(19) United States
(12) Patent Application Publication
(10) Pub. No.: US 2008/0256473 A1
(43) Pub. Date: Oct. 16, 2008

(54) System and Method to Shuffle Steps Via an Interactive Progress Bar

(76) Inventors: Al Chakra, Cary, NC (US); Angela Richards Jones, Durham, NC (US); John F. Sefler, Morrisville, NC (US); David L. Kaminsky, Chapel Hill, NC (US)

Correspondence Address: HAMILTON & TERRILE, LLP;IBM RSW, P.O. BOX 203518, AUSTIN, TX, 78720, US

(21) Appl. No.: 11/733,263

(22) Filed: Apr. 10, 2007

(51) Int. Cl. G06F 3/048

(52) U.S. Cl. 715/772

(57) ABSTRACT

A method, system and computer-usable medium are disclosed for using an interactive progress indicator bar to graphically display the completion status of a plurality of computer operations, reorder the sequence of predetermined operations before they are completed, and then restart the reordered operations. An interactive progress indicator bar is implemented in a graphical user interface (GUI) and comprises a plurality of progress indicator segments. As computer operations are completed, the details of their completion status are entered into a computer operation log and related to their corresponding progress indicator segments. Concurrently, color attributes are applied to progress indicator segments to graphically indicate the completion status of their associated computer operations. One or more progress indicator segments are selected through a first user gesture to view the completion status details of their corresponding computer operations. To change the order of the predetermined computer operation, a second user gesture is used to move its corresponding progress indicator segment to a target location on the progress indicator bar. Previously completed computer operations that are subsequent to the reordered operation are reversed and computer operations are then restarted, beginning with the reordered computer operation.

### BACKGROUND OF THE INVENTION

1. Field of the Invention

Embodiments of the disclosure relate in general to the field of computers and similar technologies, and in particular to software utilized in this field. Still more particularly, it relates to graphically displaying the completion status of computer operations and making changes to their order of operation before they are completed.

2. Description of the Related Art

Conventional computer applications often use a graphical progress indicator to provide users feedback about the completion status of computer operations as they are being performed. Progress indicators are often used during software installations, lengthy calculations, and automated test executions while back-end logs and trace files of the procedures are being written. The typical progress bar provides the user with an estimate of how much time it will take to complete the entire operation and an indication of how much progress has been made thus far.

Prior art approaches have included progress bars, which include a completion progress indicator that comprises a plurality of progress indicator segments. Completed progress indicator segments are generally depicted in a graphical user interface (GUI) as one color and uncompleted progress indicator segments in another. As increments of progress are achieved, the number of completed progress indicator segments increase and the number of uncompleted progress segments decrease. While completion progress indicators may provide some indication of how complete a series of computer operations may be, or an estimate of the time remaining until completion, they typically do not provide completion detail about individual operations. Another approach is to combine a checklist of computer operations with a time remaining progress indicator. The computer operation checklist generally comprises a list of computer operations, each of which has a corresponding graphical icon to symbolize operations that were completed successfully, with errors, or with failures. While the progress indicator with checklist provides a summary of computer operations and their corresponding status through graphical icons, it does not provide meaningful detail about failed operations.

Graphical progress indicators are often used to monitor the progress of time consuming processes such as the installation of a series of complex computer applications, each of which may require multiple configuration choices to be made during the installation process. In some cases, a series of computer operations are begun, only to later determine that it may be desirable to change the order of their execution. It would likewise be advantageous to be able to re-order the sequence of operations prior to the remaining operations being completed. This is especially true if a large number of operations have already completed or if their completion has consumed a significant amount of time. Accordingly, users should be able to change the pre-existing order of a series of computer operations by selecting their corresponding progress indicator segments and graphically reordering them on the progress indicator bar without interrupting the overall process. Furthermore, users should be able to reverse operations affected by a reordered operation and continue computer operations without completely restarting the process. However, current progress indicator approaches require the user to wait until all operations have been completed, or ended prematurely, to change the order of computer operations.

For example, FIGS. 1a-d, labeled Prior Art, show examples of progress bar indicators. Referring now to FIG. 1a, a generalized depiction of a completion progress indicator 102 is shown as typically implemented in a graphical user interface (GUI). The completion progress indicator 102 comprises completed progress indicator segments 106 and uncompleted progress indicator segments 108, representing a completion progress 104 of 37%. Completed progress indicator segments 106 are generally depicted in a GUI as one color and uncompleted progress indicator segments 108 in another. As increments of progress are achieved, the number of completed progress indicator segments 106 increase and the number of uncompleted progress segments 108 decrease. It will be appreciated that while completion progress indicators may provide some indication of how complete a series of computer operations may be, they generally do not indicate how long it will take to complete the remaining operations.

Conversely, the indeterminate time progress indicator 110 shown in FIG. 1b provides a simplified visual indication of the time remaining to complete predetermined computer operations (e.g., deleting C:\MyTrash) 112. As computer operations are completed, the slider bar 114 progresses from left to right. By observing the slider bar's 114 rate of progression, a user can achieve a general sense of how much time remains before the operations are completed. In a similar fashion, the position of the slider bar 114 indicates the proportion of completed operations 116 to uncompleted operations 118. Regardless, unlike completion progress indicator 102, indeterminate time progress indicator 110 does not provide a declarative indication of what percentage of the operations have been completed.

The time remaining progress indicator 110 shown in FIG. 1c provides a completion progress summary 122 of the number of completed computer operations as well as an estimate of how long it will take to complete the remaining operations. As operations are completed, they are enumerated within the completion progress summary 122 and a proportionate area 124 of the progress indicator bar changes color (e.g., from white to green, left-to-right) while the uncompleted operations area 126 is reduced accordingly. However, while the completion progress summary 122 may indicate the number of operations completed, it does not indicate the respective number of operations that were completed successfully, with errors, or with failures. Instead, the user is required to wait until all operations have been completed to determine whether or not they were successful.

The progress indicator with checklist 128 shown in FIG. 1d combines a checklist 138 of computer operations with a time remaining progress indicator 132. As computer operations are completed, a proportionate area 134 of the progress indicator bar changes color (e.g., from white to green, left-to-right) while the uncompleted operations area 136 is reduced accordingly. The computer operation checklist 138 comprises a plurality of computer operations, each of which has a corresponding graphical icon 140 symbolizing its individual status. For example, a checkmark may signify a successfully completed operation whereas an ‘X’ may signify a failed or partially successful operation. Similarly, a rotating icon combined with bold text may signify a computer operation that is in progress, while absence of a graphical icon may indicate that the operation has not yet begun. Concurrently, the computer operation indicator 130 provides additional details about the computer operation that is currently in progress and may indicate whether or not the operation was successful. While the progress indicator with checklist 128 provides a summary of computer operations 138 and their corresponding status through graphical icons 140, it does not provide meaningful detail about failed operations. Furthermore, the user has no way to investigate the possible causes of failed operations while the remaining operations are being completed. Instead, they must wait until all operations have completed to determine the cause of failure.

### BRIEF SUMMARY OF THE INVENTION

The present invention includes, but is not limited to, a method, system and computer-usable medium for using an interactive progress indicator bar to graphically display the completion status of a plurality of computer operations, reorder the sequence of predetermined operations before they are completed, and then restart the reordered operations. In various embodiments of the invention, an interactive progress indicator bar is implemented in a graphical user interface (GUI) and comprises a plurality of progress indicator segments. As computer operations are completed, the details of their completion status are entered into a computer operation log and related to their corresponding progress indicator segments. As increments of progress are achieved, a completion progress indicator is updated to textually reflect the percentage of completed computer operations.

Details of the completion status of a plurality of predetermined computer operations are viewed by selecting one or more corresponding progress indicator segments through a user gesture. In one embodiment, a summary list of computer operations is displayed through a first user gesture such as a mouse hover or right-click as the cursor is placed over the last progress indicator segment. In another embodiment, detail information for a predetermined range of computer operations is displayed using a first user gesture such as a mouse click-and-drag to highlight the progress indicator segments corresponding to the selected range of computer operations. A second user gesture, such as selecting a menu command displayed as the result of a mouse right-click displays the detail information for the range of operations in an operation information window.

In yet another embodiment, detail information for a predetermined computer operation is displayed through a first user gesture such as a mouse right-click as the cursor is placed over its corresponding progress indicator segment. If a decision is made to reorder the predetermined computer operation, a second user gesture such as a drag and drop operation is used to move its corresponding progress indicator segment to a target location on the progress indicator bar. Once the progress indicator segment is moved, a dialog box is opened and the user is prompted to confirm the move operation. If the reordered computer operation has dependent computer operations, then they are accommodated by adjusting the order of the other computer operations. Once adjustments to the order of the computer operations are completed, the user is prompted to restart computer operations. If the user decides to restart computer operations, previously completed computer operations that are subsequent to the reordered operation are reversed. Once the previously completed operations are reversed, computer operations are then restarted, beginning with the reordered computer operation. The above, as well as additional purposes, features, and advantages of the present invention will become apparent in the following detailed written description. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIGS. 1a-d, labeled Prior Art, show example progress bar indicators;

FIG. 2 depicts an exemplary client computer in which the present invention may be implemented;

FIGS. 3a-e show an interactive progress indicator bar;

FIGS. 4a-c show a simplified block diagram of computer operations to be reordered prior to their completion;

FIGS. 5a-d show an interactive progress bar as implemented to reorder computer operations prior to their completion; and

FIG. 6 is a generalized flow chart showing an interactive progress bar as implemented to reorder computer operations prior to their completion.

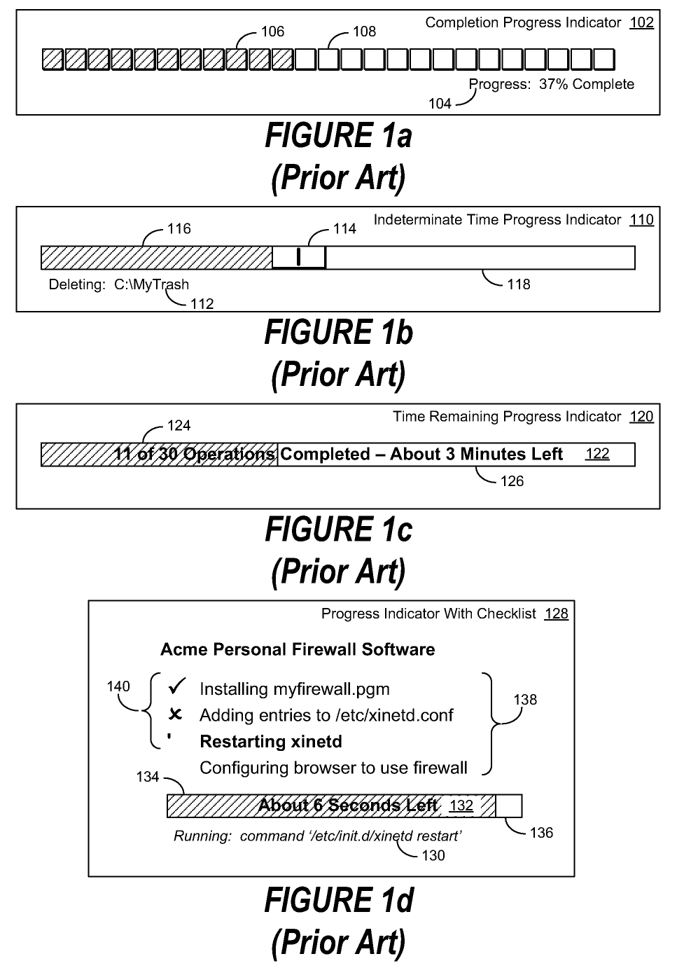

### DETAILED DESCRIPTION

A method, system and computer-usable medium are disclosed for using an interactive progress indicator bar to graphically display the completion status of a plurality of computer operations, reorder the sequence of predetermined operations before they are completed, and then restart the reordered operations. In various embodiments of the invention, an interactive progress indicator bar is implemented in a graphical user interface (GUI) and comprises a plurality of progress indicator segments. As computer operations are completed, the details of their completion status are entered into a computer operation log and related to their corresponding progress indicator segments. As increments of progress are achieved, a completion progress indicator is updated to textually reflect the percentage of completed computer operations. Details of the completion status of a plurality of predetermined computer operations are viewed by selecting one or more corresponding progress indicator segments through a user gesture.

In one embodiment, detail information for a predetermined computer operation is displayed through a first user gesture such as a mouse right-click as the cursor is placed over its corresponding progress indicator segment. If a decision is made to reorder the predetermined computer operation, a second user gesture such as a drag and drop operation is used to move its corresponding progress indicator segment to a target location on the progress indicator bar. Once the progress indicator segment is moved, a dialog box is opened and the user is prompted to confirm the move operation. If the reordered computer operation has dependent computer operations, then they are accommodated by adjusting the order of the other computer operations. Once adjustments to the order of the computer operations are completed, the user is prompted to restart computer operations. In an alternate embodiment, computer operations may be restarted automatically, or after some pre-defined delay period. If the user decides to restart computer operations, previously completed computer operations that are subsequent to the reordered operation are reversed. Once the previously completed operations are reversed, computer operations are then restarted, beginning with the reordered computer operation.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF), etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

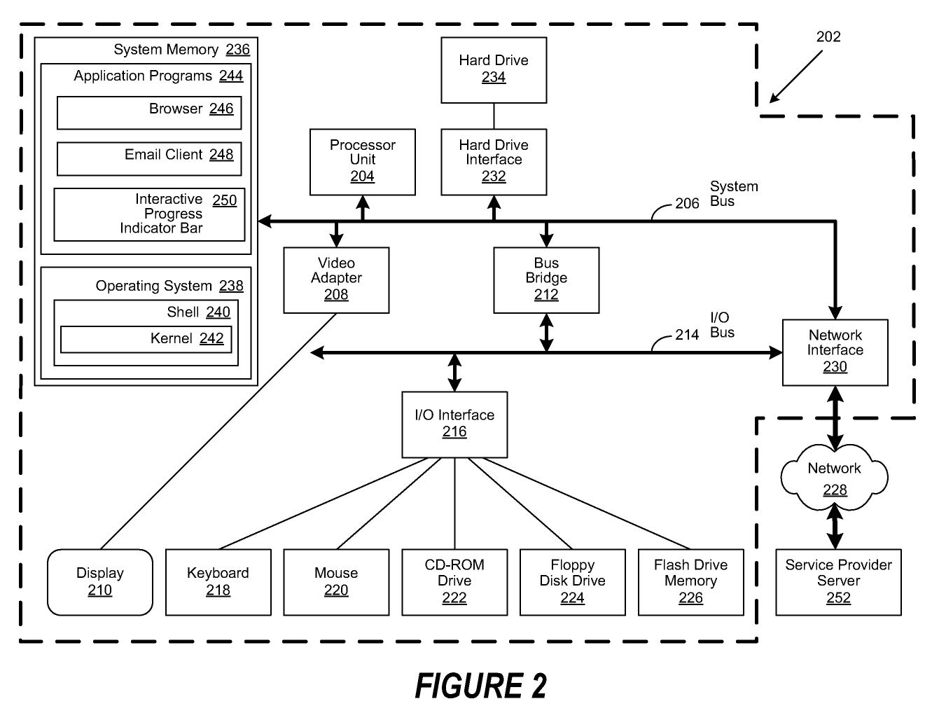

FIG. 2 is a block diagram of an exemplary client computer 202 in which the present invention may be utilized. Client computer 202 includes a processor unit 204 that is coupled to a system bus 206. A video adapter 208, which controls a display 210, is also coupled to system bus 206. System bus 206 is coupled via a bus bridge 212 to an Input/Output (I/O) bus 214. An I/O interface 216 is coupled to I/O bus 214. The I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Client computer 202 is able to communicate with a service provider server 252 via a network 228 using a network interface 230, which is coupled to system bus 206. Network 228 may be an external network such as the Internet, or an internal network such as an Ethernet Network or a Virtual Private Network (VPN). Using network 228, client computer 202 is able to use the present invention to access service provider server 252.

A hard drive interface 232 is also coupled to system bus 206. Hard drive interface 232 interfaces with a hard drive 234. In a preferred embodiment, hard drive 234 populates a system memory 236, which is also coupled to system bus 206. Data that populates system memory 236 includes the client computer's 202 operating system (OS) 238 and application programs 244.

OS 238 includes a shell 240 for providing transparent user access to resources such as application programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. While shell 240 generally is a text-based, line-oriented user interface, the present invention can also support other user interface modes, such as graphical, voice, gestural, etc.

As depicted, OS 238 also includes kernel 242, which includes lower levels of functionality for OS 238, including essential services required by other parts of OS 238 and application programs 244, including memory management, process and task management, disk management, and mouse and keyboard management.

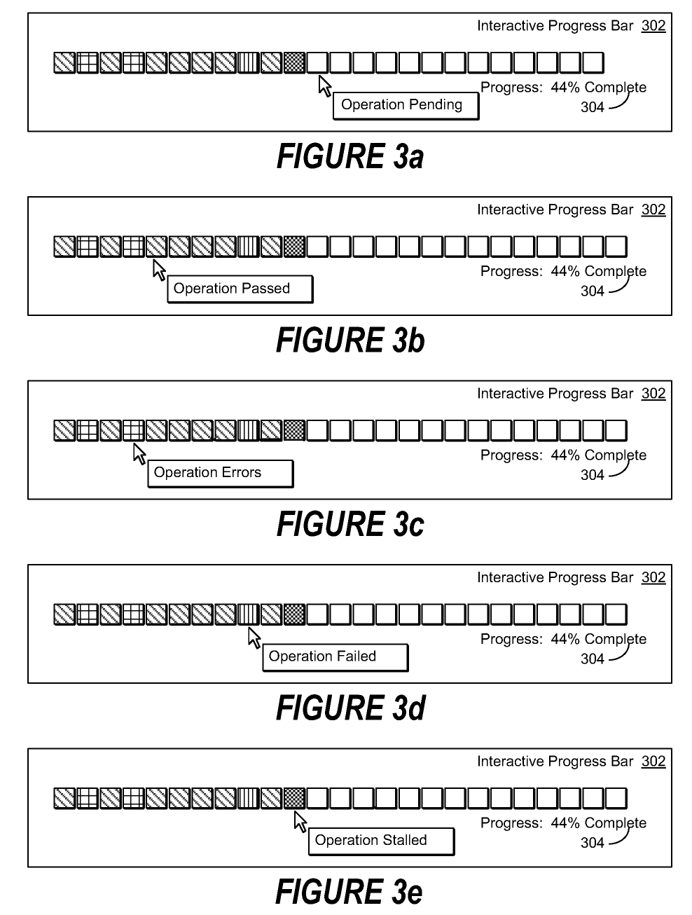

Application programs 244 may include a browser 246 and email client 248. Browser 246 includes program modules and instructions enabling a World Wide Web (WWW) client (i.e., client computer 202) to send and receive network messages to the Internet using HyperText Transfer Protocol (HTTP) messaging, thus enabling communication with service provider server 252. Application programs 244 also include an interactive progress indicator bar 250. The interactive progress indicator bar 250 includes code for implementing the processes described in FIGS. 3-6 described hereinbelow. In one embodiment, client computer 202 is able to download the interactive progress indicator bar 250 from a service provider server 252.

The hardware elements depicted in client computer 202 are not intended to be exhaustive, but rather are representative to highlight components used by the present invention. For instance, client computer 202 may include alternate memory storage devices such as magnetic cassettes, Digital Versatile Disks (DVDs), Bernoulli cartridges, and the like. These and other variations are intended to be within the spirit and scope of the present invention.

FIGS. 3a-e show an interactive progress indicator bar 302 as implemented in an embodiment of the invention. In various embodiments, the interactive progress indicator bar 302 comprises a plurality of progress indicator segments. As increments of progress are achieved, completion progress indicator 304 is updated to reflect the percentage of computer operations completed.

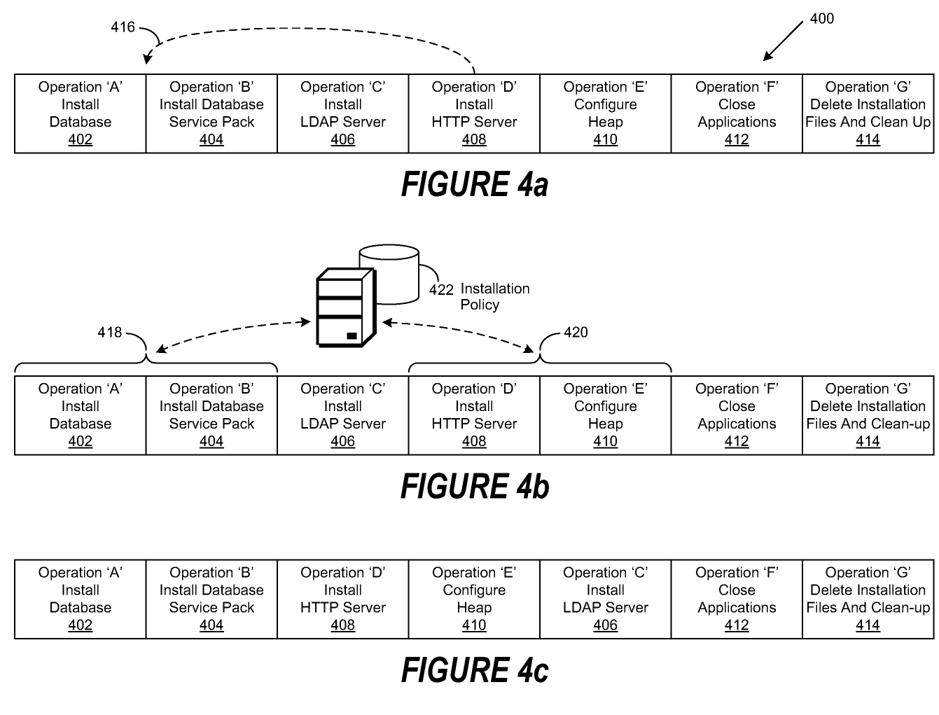

FIGS. 4a-c show a simplified block diagram of computer operations 400 to be reordered prior to their completion. In one embodiment, computer operations 400 comprise operations ‘A’ (install database) 402, ‘B’ (install database service pack) 404, ‘C’ (install LDAP server) 406, ‘D’ (install HTTP server) 408, ‘E’ (configure heap) 410, ‘F’ (close applications) 412, and ‘G’ (delete installation files and clean up) 414. As shown in FIG. 4a, the order of computer operations 400 is to be changed such that operation ‘D’ (install HTTP server) 408 is moved 416 to occur after the completion of operation ‘A’ (install database) 402. However, as shown in FIG. 4b, the installation policy 422 enforces dependency association 418, which requires operation ‘B’ (install database service pack) be performed after the completion of operation ‘A’ (install database) 402 and a prerequisite to performing other operations. Furthermore, the installation policy 422 also enforces dependency association 420, which requires operation ‘E’ (configure heap) 410 be performed after the completion of operation ‘D’ (install HTTP server) 408 and prior to performing other operations. As a result, operations ‘A’ (install database) 402 and ‘B’ (install database service pack) 404 must remain contiguous, and likewise, operations ‘D’ (install HTTP server) 408 and ‘E’ (configure heap) 410 must remain contiguous. As shown in FIG. 4c, the resulting order of computer operations 400 after reordering becomes: ‘A’ (install database) 402, ‘B’ (install database service pack) 404, ‘D’ (install HTTP server) 408, ‘E’ (configure heap) 410, ‘C’ (install LDAP server) 406, ‘F’ (close applications) 412, and ‘G’ (delete installation files and clean up) 414. Dependencies can be specified using an XML format such as:
<depends>
<element>A</element>
<element>B</element>
</depends>
   which specifies that task B depends on task A.

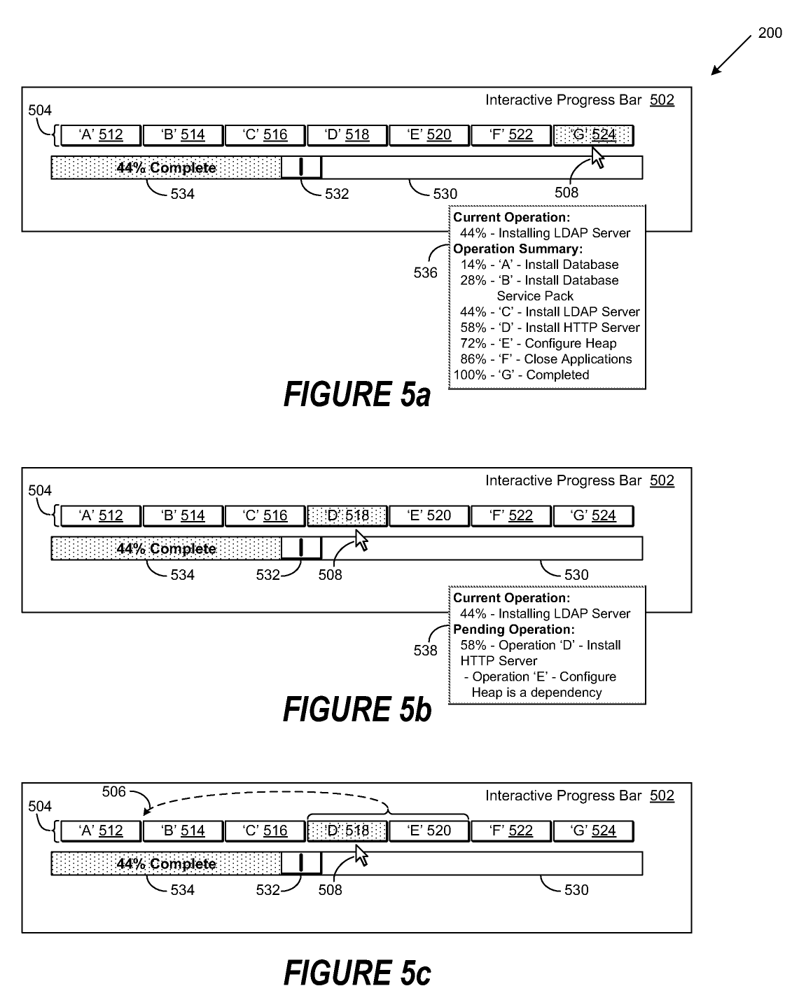

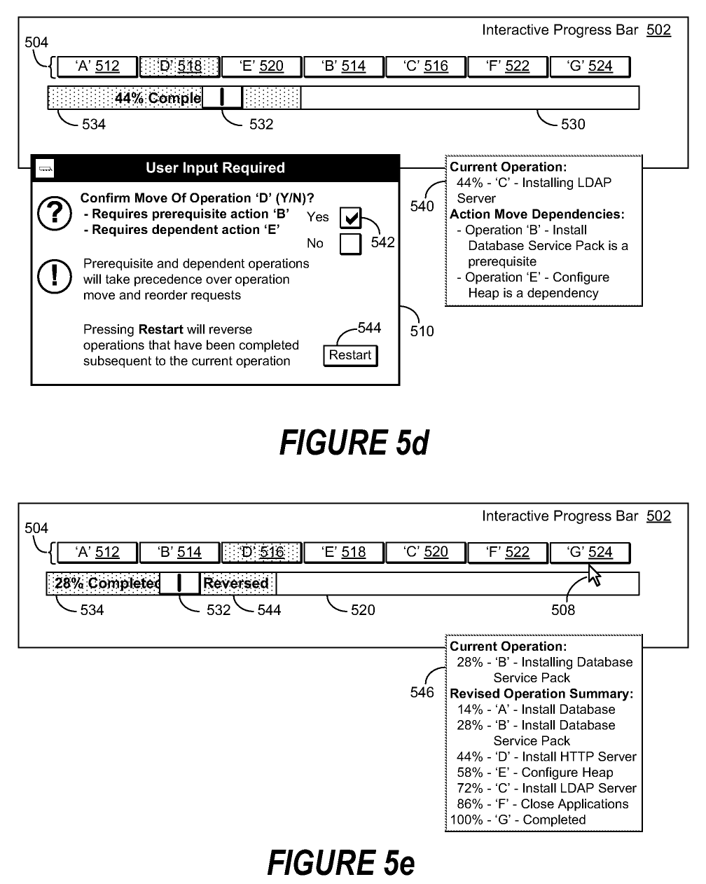

FIGS. 5a-e show an interactive progress bar 502 as implemented to reorder computer operations prior to their completion. In various embodiments, the interactive progress bar 502 is implemented in a graphical user interface (GUI) and comprises a plurality of progress indicator segments 504. As computer operations are completed, the details of their completion status are entered into a computer operation log and related to their corresponding progress indicator segments. Color attributes are applied to progress indicator segments as they are completed to graphically indicate the completion status of their associated computer operations. For example, a color attribute of green may signify a successfully completed operation, yellow a completed operation with errors, and red a failed operation. As increments of progress are achieved, completion progress indicator 534 is updated to textually reflect the percentage of completed computer operations. Concurrently, the slider bar 532 progresses from left to right, a proportionate amount of the completed operations area of the progress indicator bar changes color (e.g., from white to green), and the uncompleted operations area 530 is reduced accordingly.

In one embodiment, progress indicator segments 504 comprise segments ‘A’ 512, ‘B’ 514, ‘C’ 516, ‘D’ 518, ‘E’ 520, ‘F’ 522, and ‘G’ 524, each of which correspond to a predetermined computer operation. A summary list of computer operations is displayable through a user gesture such as a mouse hover or right-click as the cursor 508 is placed over the progress indicator segment ‘G’ 524 corresponding to the last computer operation to be completed. As shown in FIG. 5a, the operations summary list is appended to the current operation displayed in the operation information window 536. In this embodiment, the position of slider bar 532 relative to progress indicator segment ‘C’ 516 indicates that computer operations are 44% complete. Cross-referencing the current completion status 534 of 44% to the operations summary list displayed in operation information window 536 indicates that the current computer operation is to install an LDAP server. A decision to change the order of the computer operations may involve moving or reordering prerequisite and dependent computer operations at the same time. Whether or not a predetermined computer operation has prerequisite or dependent operations is determined through a user gesture such as a mouse right-click as the cursor 508 is placed over the progress indicator segment corresponding to the candidate computer operation.

As shown in FIG. 5b, application of a user gesture as the cursor 508 is placed over the progress indicator ‘D’ 518 results in summary and dependent operation information being displayed in the operation information window 538. Since operation ‘E’ (configure heap) is denoted as an operation that is dependent to operation ‘D’ (install HTTP server) in operation information window 538, any movement of operation ‘D’ will result in a corresponding movement of operation ‘E’. Accordingly, as shown in FIG. 5d, when progress indicator segment ‘D’ 518 is moved 506 through a user gesture such as a drag and drop to its target location subsequent to progress indicator segment ‘A’ 512, progress indicator segment ‘E’ 520 will be moved as well. As a result, the dependent association of operation ‘E’ (configure heap) is maintained with operation ‘D’ (install HTTP server) during the reorder operation. As also shown in FIG. 5d, moving progress indicator segment ‘D’ 518 to its target location has resulted in the corresponding movement of progress indicator segment ‘E’ 520.

Concurrently, computer operations that are in progress have been halted, the slider bar 532 is now positioned underneath the reordered progress indicator segment ‘D’ 518, and user dialog box 510 has been opened. Once opened, dialog box 510 prompts the user to confirm the move of operation ‘D’, noting that by choosing “Yes” 542, prerequisite and dependent operations will take precedence over requested move and reorder operations. At the same time, summary, prerequisite and dependent operation information is displayed in the operation information window 540. Since operation ‘B’ (install database service pack) is denoted as an operation that is prerequisite to operation ‘D’ (install HTTP server), confirmation of the move of operation ‘D’ will result in a corresponding movement of operation ‘B’ to precede operation ‘D’.

As a result, the resulting order of progress indicator segments and their corresponding computer operations will become: ‘A’ (install database) 402, ‘B’ (install database service pack) 404, ‘D’ (install HTTP server) 408, ‘E’ (configure heap) 410, ‘C’ (install LDAP server) 406, ‘F’ (close applications) 412, and ‘G’ (delete installation files and clean up) 414. The user is then notified that pressing the restart button 544 in dialog box 510 will result in the reversal of operations that were previously completed subsequent to the new current operation (‘B’—Install HTTP server). Once the operations are restarted, the current completion status 524 is reduced to 20% and the area of the progress indicator bar previously indicating completed operations is now denoted as “reversed” 544.

A revised summary list of computer operations is now displayable through a user gesture as the cursor 508 is placed over the progress indicator segment 524 corresponding to the last computer operation to be completed. As shown in FIG. 5d, the revised operations summary list appended to the current operation (‘B’—install database service pace) displayed in the operation information window 540 now reflects the new order of the progress indicator segments 504. It will be appreciated by those of skill in the art that the ability to reorder predetermined computer operations before the remaining operations are completed is advantageous, especially when the operations are large in number or time consuming to complete.

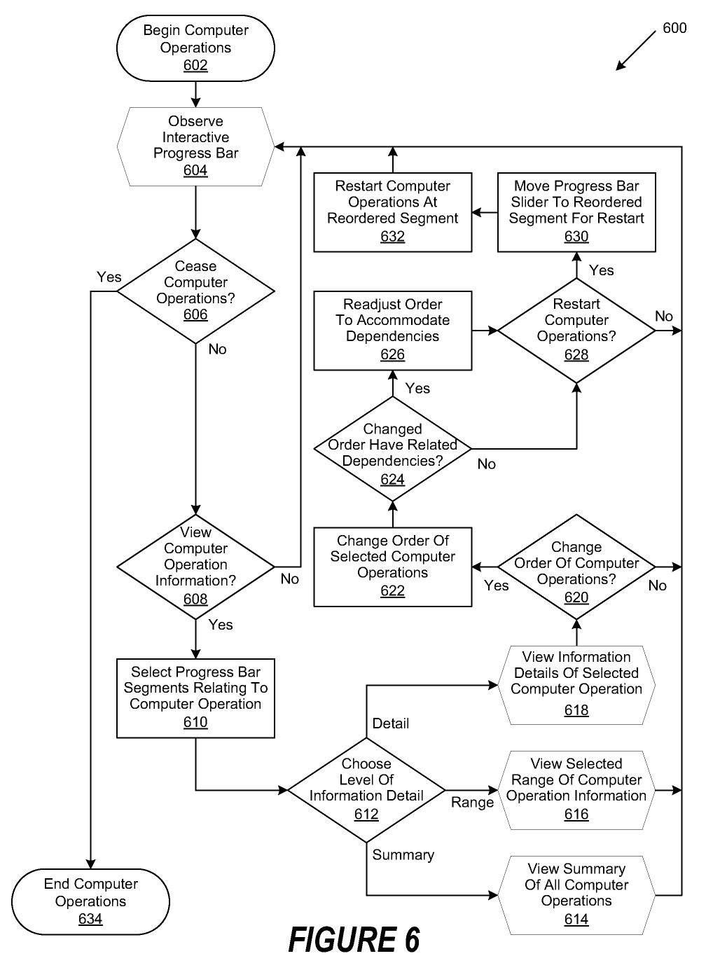

FIG. 6 is a generalized flow chart showing an interactive progress bar 600 as implemented to reorder computer operations prior to their completion. In various embodiments, an interactive progress indicator bar is implemented in a graphical user interface (GUI) and comprises a plurality of progress indicator segments. As computer operations are completed, the details of their completion status are entered into a computer operation log and related to their corresponding progress indicator segments. Concurrently, color attributes are applied to progress indicator segments as they are completed to graphically indicate the completion status of their associated computer operations. For example, a color attribute of green may signify a successfully completed operation, yellow a completed operation with errors, and red a failed operation. As increments of progress are achieved, a completion progress indicator is updated to textually reflect the percentage of completed computer operations.

In this embodiment, computer operations are begun in step 602 and the completion status of the computer operations is monitored by observing the interactive progress bar in step 604. If it is determined in step 606 to cease computer operations, then computer operations are ended in step 634. Otherwise, it is then determined in step 608 if information relating to a predetermined computer operation is to be viewed. If it is determined to not view information relating to a predetermined computer operation, then observation of the interactive progress bar continues beginning with step 604.

However, if it is determined in step 608 to view information relating to a predetermined computer operation, then a corresponding progress indicator segment is selected in step 610 and a level of computer operation detail is chosen in step 612. If a summary level of information is chosen in step 612, then a summary list of computer operation is displayed in step 614 through a first user gesture such as a mouse hover or right-click as the cursor is placed over the last progress indicator segment of the interactive progress bar. Once review of the computer operation summary list is completed, observation of the interactive progress bar continues, beginning with step 604. If detail information for a predetermined range of computer operations is chosen in step 612, then a first user gesture such as a mouse click-and-drag is used to highlight the progress indicator segments corresponding to the selected range of computer operations. Detail information for the range of operations is then displayed in step 616 as a result of a second user gesture such as selecting a menu command displayed as the result of a mouse right-click. Once review of the detail information for the range of computer operations is complete, observation of the interactive progress bar continues, beginning with step 604.

If detail information for a predetermined computer operation is chosen in step 612, then the detail information is displayed in step 618 through a user gesture such as a mouse right-click as the cursor is placed over its corresponding progress indicator segment. Once review of the detail information is complete, it is then determined in step 620 whether the order of the predetermined computer operation is to be changed. If a decision is made to not change the order of the predetermined computer operation, then observation of the interactive progress bar continues, beginning with step 604. Otherwise, changes in the order of the predetermined computer operation are made in step 622 as described in greater detail herein. Once changes are made to the order of the predetermined computer operation in step 622, it is then determined in step 624 whether the reordered computer operation has dependent or prerequisite computer operations.

If it is determined in step 624 that the reordered computer operation has dependent or prerequisite computer operations, then the order of the other computer operations are adjusted to accommodate the dependent and prerequisite operations in step 626. It is then determined in step 628 if computer operations are to be restarted. If it is determined in step 628 to not restart computer operations, then observation of the interactive progress bar continues, beginning with step 604. Otherwise, the progress bar slider is automatically moved in step 630 to the progress indicator segment corresponding to the reordered computer operation. Previously completed computer operations that are subsequent to the reordered operation are then reversed. Once the previously completed operations are reversed, computer operations are restarted in step 632, beginning with the reordered computer operation. Observation of the interactive progress bar then continues, beginning with step 604.

If it is determined in step 624 that the reordered computer operation has no dependent or prerequisite computer operations, then it is determined in step 628 if computer operations are to be restarted. If it is determined in step 628 to not restart computer operations, then observation of the interactive progress bar continues, beginning with step 604. Otherwise, the progress bar slider is automatically moved in step 630 to the progress indicator segment corresponding to the reordered computer operation. Previously completed computer operations that are subsequent to the reordered operation are then reversed. Once the previously completed operations are reversed, computer operations are restarted in step 632, beginning with the reordered computer operation. Observation of the interactive progress bar then continues, beginning with step 604.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of skill in the art without departing from the scope and spirit of the invention. The embodiment was chosen and described in order to best explain the principles of the invention and the practical application, and to enable others of skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for reordering the sequence of a plurality of computer operations within a graphical user interface, comprising:
representing a status of a plurality of computer operations using at least one graphical progress display;
displaying the graphical progress display as a plurality of graphical status elements, the plurality of graphical status elements relating to the plurality of computer operations; and
enabling interaction with the plurality of graphical status elements to allow the plurality of computer operations to be shuffled.

2. The method of claim 1, wherein the at least one graphical progress display comprises a progress bar.

3. The method of claim 2, wherein the graphical progress bar comprises graphical controls operable to select predetermined graphical status elements for:
reversing predetermined related computer operations that have been completed;
modifying predetermined related computer operations;
reordering the sequence of predetermined computer operations; and
restarting the reordered sequence of predetermined computer operations.

4. The method of claim 1, wherein the plurality of graphical status elements are configurable to display a color attribute, the color attribute indicating whether a graphical status element is a dependent graphical status element, the color attribute informing a user that shuffling one graphical status element could result in other segments of a group of graphical status elements being moved.

5. The method of claim 1, wherein the interaction with the information associated with the plurality of related computer operations is performed before the plurality of computer operations are completed.

6. The method of claim 5, wherein the interaction with the information associated with a predetermined related computer operation comprises a dependent interaction with at least one other related computer operation.

7. A system comprising:
a processor;
a data bus coupled to the processor; and
a computer-usable medium embodying computer program code, the computer-usable medium being coupled to the data bus, the computer program code interacting with a plurality of computer operations and comprising instructions executable by the processor and configured for:
representing a status of a plurality of computer operations using at least one graphical progress display;
displaying the graphical progress display as a plurality of graphical status elements, the plurality of graphical status elements relating to the plurality of computer operations; and
enabling interaction with the plurality of graphical status elements to allow the plurality of computer operations to be shuffled.

8. The system of claim 7, wherein the at least one graphical progress display comprises a progress bar.

9. The system of claim 8, wherein the graphical progress bar comprises graphical controls operable to select predetermined graphical status elements for:
reversing predetermined related computer operations that have been completed;
modifying predetermined related computer operations;
reordering the sequence of predetermined computer operations; and
restarting the reordered sequence of predetermined computer operations.

10. The system of claim 7, wherein the plurality of graphical status elements are configurable to display a color attribute, the color attribute indicating whether a graphical status element is a dependent graphical status element, the color attribute informing a user that shuffling one graphical status element could result in other segments of a group of graphical status elements being moved.

11. The system of claim 7, wherein the interaction with the information associated with the plurality of related computer operations is performed before the plurality of computer operations are completed.

12. The system of claim 11, wherein the interaction with the information associated with a predetermined related computer operation comprises a dependant interaction with at least one other related computer operation.

13. A computer-usable medium embodying computer program code, the computer program code comprising computer executable instructions configured for:
representing a status of a plurality of computer operations using at least one graphical progress display;
displaying the graphical progress display as a plurality of graphical status elements, the plurality of graphical status elements relating to the plurality of computer operations; and
enabling interaction with the plurality of graphical status elements to allow the plurality of computer operations to be shuffled.

14. The computer usable medium of claim 13, wherein the at least one graphical progress display comprises a progress bar.

15. The computer usable medium of claim 14, wherein the graphical progress bar comprises graphical controls operable to select predetermined graphical status elements for:
reversing predetermined related computer operations that have been completed;
modifying predetermined related computer operations;
reordering the sequence of predetermined computer operations; and
restarting the reordered sequence of predetermined computer operations.

16. The computer usable medium of claim 13, wherein the plurality of graphical status elements are configurable to display a color attribute, the color attribute indicating whether a graphical status element is a dependent graphical status element, the color attribute informing a user that shuffling one graphical status element could result in other segments of a group of graphical status elements being moved.

17. The computer usable medium of claim 13, wherein the interaction with the information associated with the plurality of related computer operations is performed before the plurality of computer operations are completed.

18. The computer usable medium of claim 17, wherein the interaction with the information associated with a predetermined related computer operation comprises a dependant interaction with at least one other related computer operation.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
